(19) United States
(12) Patent Application Publication
(10) Pub. No.: US 2010/0215800 A1
(43) Pub. Date: Aug. 26, 2010

(54) CACAO LIQUOR AND PROCESS FOR PRODUCING THE SAME

(75) Inventor: Takashi Sasaki, Akita (JP)

Correspondence Address: DRINKER BIDDLE & REATH (DC), 1500 K STREET, N.W., SUITE 1100, WASHINGTON, DC, 20005-1209, US

(73) Assignee: Goumeikaisha Akitafujishuzouten, Daisen-shi, Akita (JP)

(21) Appl. No.: 12/600,022

(22) PCT Filed: May 12, 2008
(86) PCT No.: PCT/JP2008/058742

§ 371 Date: Nov. 13, 2009

(30) Foreign Application Priority Data
May 16, 2007 (JP) 2007-130185

(51) Int. Cl. C12G 3/02; C12H 1/00; A23L 1/36

(52) U.S. Cl. 426/12; 426/592; 426/11; 426/15; 426/629

(57) ABSTRACT

A novel cacao liquor and a process for producing the same are provided. The process for producing a cacao liquor specifically comprises the following steps: (1) preparing cacao beans; (2) milling the cacao beans and dipping in water; (3) steaming the cacao beans; and (4) after adding (i) one or both of koji and an enzyme, (ii) yeast, (iii) a saccharide-containing fruit or its juice and (vi) water to the steamed cacao beans followed by alcohol fermentation. Between the step (3) of milling and dipping the cacao beans and the step (4) of the alcohol fermentation, it is also possible to prepare the starter step (3-1) wherein (i) one or both of koji and an enzyme, (ii) yeast, (iii) a saccharide-containing fruit or its juice and (vi) water are added to the steamed cacao beans to promote the proliferation of the yeast.

### TECHNICAL FIELD

The present invention relates to a cacao liquor and a process for producing the same.

### BACKGROUND ART

Generally, a fruit liqueur is well known as one of alcoholic beverages. The fruit liqueur is one of liqueurs each is prepared by infusing or soaking a certain fruit in a high-alcohol clear distilled spirit with added sugar. The infused materials in the distilled spirit are a great variety of things such as fruits, herbs, medicinal herbs, flowers, or the like. Generally, an Ume liqueur, strawberry liqueur, cherry liqueur, loquat liqueur, apricot liqueur, lemon liqueur, or the like is well known and consumed very well.

There is Creme de Cacao as One of fruit liqueurs using Theobroma cacao (Cacao), which is a brown liqueur with an aroma, sweet taste, and flavor by adding roasted cacao beans to a distilled liquor in general. Further, there is also known a white cacao of colorless and transparent liqueur which is made from the brown liqueur by steaming. The fruit liqueurs using cacao are used for a cocktail, and Cacao Fizz including Creme de Cacao, soda water, etc. is well known.

Further, the present inventor does not know any Patent document disclosing a cacao liquor and a process for producing the same as described below.

### DISCLOSURE OF THE INVENTION

### Task to be Solved by the Invention

Whereas, there is entirely unknown a liquor produced by fermenting the fruit of “cacao” per se instead of soaking the fruit of “cacao” in the distilled spirit.

### Means for Solving the Task

Thus it is an object of the present invention to provide a novel cacao liquor produced by fermenting the fruit of “cacao” per se.

In addition, it is also an object of the present invention to provide a novel process for producing the cacao liquor by fermenting the fruit of “cacao” per se.

The present invention has been made in view of the above objects, the cacao liquor according to the present invention is a cacao fermented liquor produced by fermenting cacao beans per se.

In addition, the cacao liquor producing process for producing a cacao liquor according to the present invention includes a step of fermenting cacao beans per se.

In addition, the foregoing process for producing a cacao liquor comprises the steps of:

(1) preparing cacao beans;
(2) milling the cacao beans and dipping the cacao beans in water;
(3) steaming the cacao beans; and
(4) adding (i) one or both of a koji and an enzyme, (ii) yeast, (iii) a saccharide-containing fruit or its juice and (vi) water to the steamed cacao beans to obtain a mixture thereof to make alcoholic fermentation occur in the mixture.

After the step (3) of milling and dipping the cacao beans and before the step (4) of the alcoholic fermentation, i.e., between the steps (3) and (4), it is also possible that the process further comprises a starter step (3-1) wherein (i) one or both of a koji and an enzyme, (ii) yeast, (iii) a saccharide-containing fruit or its juice and (vi) water are added to the steamed cacao beans to promote the proliferation of the yeast.

In addition, in the foregoing cacao liquor producing process, it is possible that said saccharide-containing fruit or its juice includes at least one selected from a group that consists of a red grape, a red grape juice, raisins, apples, apple juice, blueberries and blueberry juice.

In addition, in the foregoing cacao liquor producing process, said saccharide-containing fruit or its juice includes a red grape or a red grape condensed juice, which may be added step by step to the steamed cacao beans.

Further, in the step (4) of the alcoholic fermentation and the shubo starter preparation step (3-1) of the foregoing cacao liquor producing process, said koji is rice koji.

In addition, in the foregoing cacao liquor producing process, low temperature fermentation is preformed in the latter half of the fermentation step in the step (4) of the alcoholic fermentation.

In addition, in the foregoing cacao liquor producing process, the prepared cacao beans are fermented cacao beans or non-fermented cacao beans.

### ADVANTAGEOUS EFFECT OF THE INVENTION

According to the present invention, the cacao liquor produced by fermenting the fruit of “cacao” per se can be obtained.

According to the present invention, the cacao liquor producing process for producing a cacao liquor comprising a step of fermenting the fruit of “cacao” per se can be obtained.

### BRIEF DESCRIPTION OF THE DRAWINGS

FIG. 1 is a diagram showing a flow of a cacao liquor producing process according to the present embodiment.

### DETAILED DESCRIPTION OF THE INVENTION

Below, embodiments of the cacao liquor and a process for producing the same according to the present invention are explained in detail, referring to the drawings. Further, in the FIGURE, the same elements are indicated by the same reference numerals, so description of the overlapped same description for the same elements will be omitted hereafter.

### First Embodiment

The first embodiment relates to a cacao liquor and a brewing process for producing the same.

(Cacao)

Cacao tree is an evergreen tree in the family Sterculiaceae, native to the tropical region of the Central and South Americas. Fruit of cacao pod has a 1 cm or more thick hard shell having a large diameter almond nut shape (long oval-shaped or ovoid) with a 15-30 cm long and a 7-12 cm diameter. The pods are produced directly on the trunk of tree. The cacao pod contains 20 to 60 seeds embedded in a sweet, white and sticky pulp, those are cacao beans.

The duration of the fermentation depends on the variety and is from 2 to more than 7 days. The cacao beans taken out of pods are rendered fermentation in the duration of about 5 days. After the fermentation is terminated the cacao beans are sun-dried. After dried, the cacao beans are cleaned, polished and packed with jute bags and then are shipped. The cacao beans are raw materials used in manufacturing cocoa and chocolate in general.

The cacao used for the cacao liquor and the process for producing the same according to the present embodiment are such cacao beans or non-fermented cacao beans.

(Cacao Liquor)

The cacao liquor of the present embodiment is an alcoholic beverage produced from cacao beans as a main material. The cacao liquor is different from the fruit liqueur “Creme de Cacao” produced from a distilled liquor in which cacao is soaked. The cacao liquor is an alcoholic beverage produced by fermenting cacao per se without using any distilled liquor, alcohol or the like.

(Cacao Liquor Producing Process)

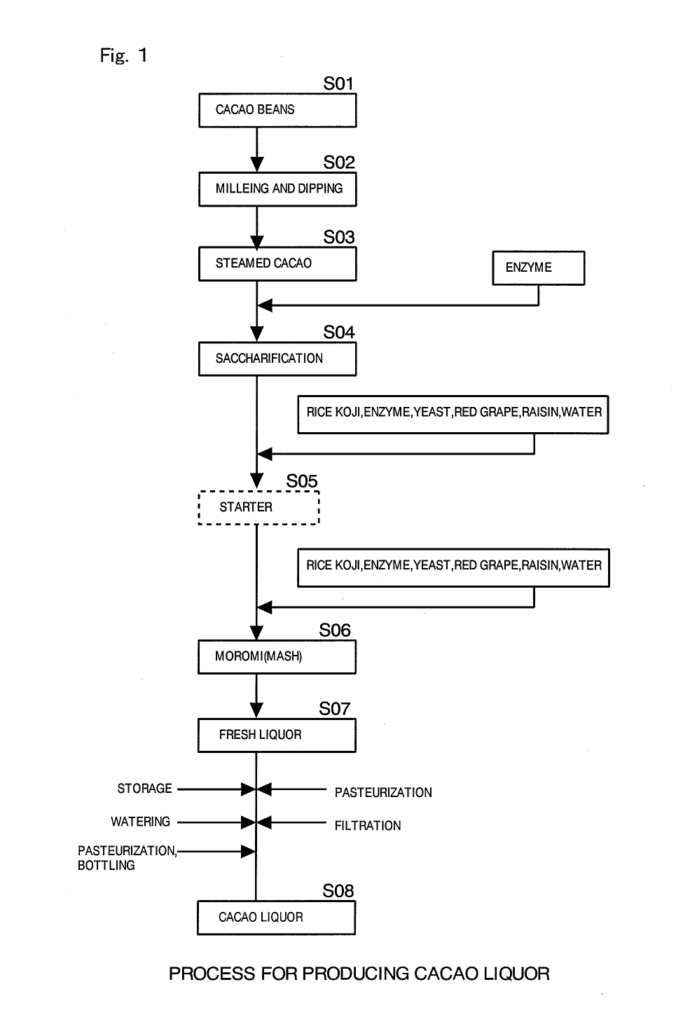

The cacao liquor producing process of the present embodiment is similar to a method for producing Japanese sake very well. The cacao liquor producing process is explained referring to FIG. 1. The cacao liquor producing process will be described using terminology for manufacture of Japanese sake, since the cacao fermented liquor is novel and not previously experienced.

Cacao beans are prepared or provided in the step 501.

In the step S02, the cacao beans are crashed and milled to be rendered in saccharification readily, after that, its cacao meal is steeped in water to absorb necessary water content. As a result, cacao beans are modified to paste. The paste is left overnight.

In the step S03, the cacao paste with the water content is steamed. This steaming step is preformed under a pressurized condition of, for example, a 0.8 atm (1013×0.8 hPa) pressure, a 117° C. temperature, and a 45 min. time period. The steamed cacao paste is cooled to human body temperature.

In the step 04, a saccharification step is preformed. For example, predetermined enzyme is added to the steamed cacao paste to be rendered saccharification. For such enzyme for brewing Sake may be utilized.

As the enzyme for brewing Sake, “glucu SBG” Amano enzyme Inc., Nagoya Aichi Japan is available in the market. The “glucu SBG” is a complex enzyme agent compounded of Amylases of liquefaction type and saccharification type which are obtained by culturing and refining through a unique method strains which are select carefully from Bacillus subtilis and filamentous fungi. The “glucu SBG” has functions of effective liquefaction and saccharification of steamed rice. The “glucu SBG” has also a function to strengthen respective saccharifications at amazake-adding of 4th shikomi stage and kumidashi-treatment of 4th shikomi stage. For example, the “glucu SBG” of 2 g is added to a steamed cacao 500 g, and then the cacao is maintained at a temperature 55° C. for 8 hours as a saccharification step.

In the step 05, shubo (starter mash) is prepared. After the saccharification step, rice koji, yeast, a saccharide-containing fruit (or its juice) and water are added to the cacao to be a shubo starter. Enzyme may be used together with rice koji or enzyme may be used instead of rice koji in this step.

The foregoing “glucu SBG” may be used as an enzyme.

In addition, lactic acid may be added to the cacao if desired.

Sake yeast for brewing of Sake may be used as yeast. Sake yeast is available in the market. For example, sake yeast “Akita-Ryu-Hanakobo, AK-1” is used for the cacao. The “AK-1” has been jointly researched and developed by the Akita Research Institute for Food and Brewing; Akita Prefectural Agriculture, Forestry and Fisheries Research Center and the Akita Prefectural Brewery Association. Yeast has a function of converting saccharide caused by koji enzyme into ethyl alcohol and carbon dioxide.

A saccharide-containing fruit or its juice is preferably, a red grape or a red grape condensed juice. Furthermore, as a saccharide-containing fruit or its juice, raisins, apples, apple juice, blueberries and blueberry juice may be used.

This shubo starter preparation step S05 is a previous step to accelerate the multiplication of yeast for the next step although the next step S06 is a moromi mash preparation step of major alcoholic fermentation step. Therefore, the shubo starter preparation step is optional. The shubo starter preparation step may be omitted and by increasing the quantity of yeast at a beginning, directly, the moromi mash preparation step may be started.

In the step S06, a moromi mash (fermentation mash) is prepared. Similarly to the shubo starter preparation step S05, rice koji, yeast, a saccharide-containing fruit (or its juice) and water are added to the shubo starter to be moromi mash. Enzyme may be used together with rice koji or only enzyme may be used instead of rice koji in this step.

The foregoing “glucu SBG” may be used as an enzyme. In addition, lactic acid may be added to the cacao if desired.

A saccharide-containing fruit or its juice is preferably, a red grape or a red grape condensed juice. Furthermore, raisins, apples, apple juice, blueberries or blueberry juice may be used as a saccharide-containing fruit or its juice. Thus, a saccharide-containing fruit (or its juice) and water are added step by step to the steamed cacao resulting in alcoholic fermentation to make a moromi mash. By such a gradual adding step, the saccharification and fermentation are accelerated so that alcohol is generated in the moromi mash.

For example, water and a red grape condensed juice are added to the shubo starter and then the Brix degree of the mixture is adjusted, and after that, yeast is added to the mixture to be a moromi mash. In this time, raisins or a saccharide-containing fruit (for example, apples, blueberry or the like) or its juice are added to the moromi mash.

Further, if the shubo starter preparation step S05 of yeast multiplication step is omitted then it is necessary to increase the quantity of yeast previously in the cacao passing through the saccharification step S04. Thus, directly, the moromi mash preparation step may be started.

In the manufacturing embodiment, the shubo starter preparation step was omitted and then, after the saccharification step, water 50 milliliters and a red grape condensed juice and raisins and rice koji 30 g were added to the cacao 10 g to perform the alcoholic fermentation.

On the 1st day: the fermentation was started at a temperature 25° C.

On the 2nd day: A 50 milliliters water was added to the cacao, and its temperature rose to 30° C., and it was recognized that a major fermentation occurred.

On the 3rd day: A red grape condensed juice of 1 milliliter was added to the cacao, and its temperature was 30° C.

On the 4th day: Its temperature was 30° C.

On the 5th day: Its temperature dropped to 6° C. After that, it entered a low temperature fermentation step.

On the 7th day: The fermentation step ended.

In the step S07, a fresh fermented liquor was prepared. After the fermentation step, the moromi mash was pressed to separate into a fresh liquor and cacao lees. The fresh cacao liquor had a Brix degree of 9.0 and its alcohol content was 11.35.

In the step S08, the cacao liquor was prepared. The obtained fresh liquor was thermally sterilized to prevent the putrefaction and deterioration of the liquor if necessary. If dregs remains then the fresh liquor is left at low temperature in a dark site for the dreg sedimentation or filtered with a strainer to be clarified. The pasteurized liquor is stored in a storage tank and aged. If necessary a further second pasteurization may be preformed to be thermally sterilized. After that, the liquor is bottled and shipped.

As described above, the cacao liquor can be produced.

### Merits of the First Embodiment

(1) A novel cacao liquor can be produced.

(2) A novel cacao liquor producing process can be achieved.

(3) Fermentation of cacao beans can be achieved due to the adding step of the red grape condensed juice.

(4) Good aroma and sulfide perfume-free can be achieved by the shubo starter preparation step for accelerating a little alcoholic fermentation or by the moromi mash preparation step of the major alcoholic fermentation step using rice koji.

(5) Good aroma and sulfide perfume-free of products also can be achieved by the low temperature fermentation performed in the latter half of the alcoholic fermentation.

(6) The cacao liquors exerting cacao's advantageous effects at the maximum can be prepared. Concretely, cacao beans have polyphenols. The polyphenols having an anti-oxidation activity become a focus of attention as substances to protect a human body from reactive oxygen causing diseases such as cancer, Arteriosclerosis or the like. Particularly there is so-called as cacao-mass-polyphenols contained in cacao beans. The cacao-mass-polyphenols can be expected in preventing Arteriosclerosis and cancer and in having an advantageous effect overcoming human stress and against allergosis and rheumatism.

### Second Embodiment

The second embodiment is a cacao natto and a process for producing the same using cacao beans. The cacao natto is prepared by adding Bacillus subtilis var. natto to the cacao after the saccharification step S04 as shown in FIG. 1 and by performing the fermentation of the cacao. Natto itself is known as fermented soybeans.

### Third Embodiment

The third embodiment is cacao vinegar and a process for producing the same using cacao beans. The cacao vinegar is prepared by adding Acetobacter to the cacao after the cacao liquor settling step S08 as shown in FIG. 1.

### Fourth Embodiment

The fourth embodiment is a cacao health food and a process for producing the same using cacao beans. There is used the cacao lees prepared after pressing the moromi mash to separate the cacao liquor therefrom in the first embodiment for producing the cacao health food. Thus this process for producing the cacao health food includes the cacao liquor producing process above mentioned. In order to remove the alcohol components contained in the cacao lees, the obtained cacao lees are dried in a drying step. The dried cacao lees become cacao health foods as it is. After the drying step, at least one of fruit, juice, dried fruit, saccharides and the other hoods may be added to the dried cacao lees if desired.

[Miscellaneous]

In the above description, the embodiments of the cacao liquor and a process for producing the same according to the present invention are illustrated, but the present invention is not limited thereby. The present invention includes any addition, suppression, modification, refinement or the like which may be readily performed by those skilled in the art.

The technological scope of the present invention is defined by the description as set forth in the appended claims.

1. Cacao liquor produced by fermenting cacao beans per se.

2. A cacao liquor producing process for producing a cacao liquor comprising a step of fermenting cacao beans per se.

3. The cacao liquor producing process according to claim 2, further comprising the steps of:
(1) preparing cacao beans;
(2) milling the cacao beans and dipping the cacao beans in water;
(3) steaming the cacao beans; and
(4) adding (i) one or both of a koji and an enzyme, (ii) yeast, (iii) a saccharide-containing fruit or its juice and (vi) water to the steamed cacao beans to obtain a mixture thereof to make alcoholic fermentation occur in the mixture.

4. The cacao liquor producing process according to claim 3, further comprising: a starter step (3-1) wherein (i) one or both of a koji and an enzyme, (ii) yeast, (iii) a saccharide-containing fruit or its juice and (vi) water are added to the steamed cacao beans to promote the proliferation of the yeast, between the step (3) of milling and dipping the cacao beans and the step (4) of the alcoholic fermentation.

5. The cacao liquor producing process according to claim 3 or 4, wherein said saccharide-containing fruit or its juice includes at least one selected from a group that consists of a red grape, a red grape juice, raisins, apples, apple juice, blueberries and blueberry juice.

6. The cacao liquor producing process according to claim 3 or 4, wherein said saccharide-containing fruit or its juice includes a red grape or a red grape condensed juice, which may be added as a step.

7. The cacao liquor producing process according to claim 3 or 4, wherein said koji is a rice koji which is used the step (4) of the alcoholic fermentation and the shubo starter preparation step (3-1).

8. The cacao liquor producing process according to claim 3 or 4, wherein a low temperature fermentation is preformed in the latter half of the fermentation step in the step (4) of the alcoholic fermentation.

9. The cacao liquor producing process according to claim 3 or 4, wherein the prepared cacao beans are fermented cacao beans or non-fermented cacao beans.

10. Cacao liquor produced by a cacao liquor producing process comprising the steps of:
(1) preparing cacao beans;
(2) milling the cacao beans and dipping the cacao beans in water;
(3) steaming the cacao beans; and
(4) adding (i) one or both of a koji and an enzyme, (ii) yeast, (iii) a saccharide-containing fruit or its juice and (vi) water to the steamed cacao beans to obtain a mixture thereof to make alcoholic fermentation occur in the mixture.

11. The cacao liquor according to claim 10, the cacao liquor producing process further comprising: a starter step (3-1) wherein (i) one or both of a koji and an enzyme, (ii) yeast, (iii) a saccharide-containing fruit or its juice and (vi) water are added to the steamed cacao beans to promote the proliferation of the yeast, between the step (3) of milling and dipping the cacao beans and the step (4) of the alcoholic fermentation.

12. A cacao health food produced by a cacao health food producing process comprising the steps of:
(1) preparing cacao beans;
(2) milling the cacao beans and dipping the cacao beans in water;
(3) steaming the cacao beans;
(4) adding (i) one or both of a koji and an enzyme, (ii) yeast, (iii) a saccharide-containing fruit or its juice and (vi) water to the steamed cacao beans to obtain a mixture thereof to make alcoholic fermentation occur in the mixture as a moromi mash;
(5) pressing the moromi mash to separate cacao liquor therefrom to obtain cacao lees; and
(6) removing alcohol components contained in the cacao lees result in obtaining cacao health food.

13. The cacao health food according to claim 12, the cacao health food producing process further comprising: after the removing step, adding at least one of fruit, juice, dried fruit, saccharides and other hoods to the cacao lees.

14. The cacao health food according to claim 12, the cacao health food producing process further comprising: a starter step (3-1) wherein (i) one or both of a koji and an enzyme, (ii) yeast, (iii) a saccharide-containing fruit or its juice and (vi) water are added to the steamed cacao beans to promote the proliferation of the yeast, between the step (3) of milling and dipping the cacao beans and the step (4) of the alcoholic fermentation.
